(19) United States
(12) Patent Application Publication
(10) Pub. No.: US 2021/0329744 A1
(43) Pub. Date: Oct. 21, 2021

(54) HIGH-SAFETY ELECTRIC HEATING COLD-RESISTANT APPARATUS

(71) Applicant: Shenzhen ZhuoChuangYu Technology Co., Ltd., Shenzhen (CN)

(72) Inventor: HUA ZHAO, SHENZHEN (CN)

(73) Assignee: Shenzhen ZhuoChuangYu Technology Co., Ltd.

(21) Appl. No.: 16/900,849

(22) Filed: Jun. 12, 2020

(30) Foreign Application Priority Data
Apr. 20, 2020 (CN) 202020599082.7

(51) Int. Cl. H05B 3/34

(52) U.S. Cl. CPC H05B 3/342; A41D 13/0051

(57) ABSTRACT

The present utility model discloses a high-safety electric heating cold-resistant apparatus, including a heat-dissipation fixing base, a fiber electric heating wire, a control switch, and a power connector, where the fiber electric heating wire is folded back and forth and fixed on the heat-dissipation fixing base, the control switch is electrically connected to two ends of the fiber electric heating wire, and the power connector is electrically connected to the control switch by using a conducting wire. The present utility model makes the apparatus applicable to clothes, a waistband, or gloves, and enables the gloves, clothes, or waistband to have an auxiliary electric heating function. The control switch has three positions: high, middle, and low, for displaying and temperature control. The apparatus has a simple structure, and can be applied conveniently. In addition, the apparatus has high safety, and can detect and display a temperature.

### CROSS-REFERENCE TO RELATED APPLICATIONS

This application claims priority to Chinese Patent Application No. 202020599082.7 with a filing date of Apr. 20, 2020. The content of the aforementioned application, including any intervening amendments thereto, are incorporated herein by reference.

### TECHNICAL FIELD

The present utility model relates to the technical field of heating apparatuses, and in particular, to a high-safety electric heating cold-resistant apparatus.

### BACKGROUND

It is cold in winter. People need to wear thick clothes to resist the cold. However, thick clothes are inconvenient for activities of people. Currently, there is no general-purpose apparatus applicable to clothes, waistbands, or gloves.

### SUMMARY

To solve the problem in the prior art, the present utility model provides a high-safety electric heating cold-resistant apparatus. The apparatus can be applied to clothes, a waistband, or gloves. The apparatus has a simple structure, and can be applied conveniently. In addition, the apparatus has high safety, and can detect and display a temperature.

To achieve the foregoing objective, the present utility model provides a high-safety electric heating cold-resistant apparatus, including a heat-dissipation fixing base, a fiber electric heating wire, a control switch, and a power connector, where the fiber electric heating wire is folded back and forth and fixed on the heat-dissipation fixing base, the control switch is electrically connected to two ends of the fiber electric heating wire, and the power connector is electrically connected to the control switch by using a conducting wire.

Preferably, a temperature sensor is disposed on the heat-dissipation fixing base, and the temperature sensor is connected to a display screen.

Two sides of the heat-dissipation fixing base stick to each other to form a velcro.

Preferably, the fiber electric heating wire is sleeved with an insulation tube.

Preferably, the fiber electric heating wire goes through two sides of the heat-dissipation fixing base back and forth and is fixed on the heat-dissipation fixing base.

Advantageous effects of the present utility model are as follows: Because the heat-dissipation fixing base, the fiber electric heating wire, the control switch, and the power connector are applied in the heating apparatus, the present utility model makes the apparatus applicable to clothes, a waistband, or gloves. The apparatus has a simple structure, and can be applied conveniently. In addition, the apparatus has high safety, and can make a human body feel warmer, so that a thickness of clothes can be reduced. In addition, the apparatus can detect and display a temperature.

### BRIEF DESCRIPTION OF DRAWINGS

The foregoing and other features, properties, and advantages of the present utility model become clearer in the following descriptions in combination with the accompanying drawings and embodiments. Same reference signs in the drawings always represent same features.

FIG. 1 is a schematic diagram of a high-safety electric heating cold-resistant apparatus according to the present utility model.

In the drawing, 1—heat-dissipation fixing base, 2—fiber electric heating wire, 3—control switch, 4—power connector, and 5—display screen.

### DESCRIPTION OF EMBODIMENTS

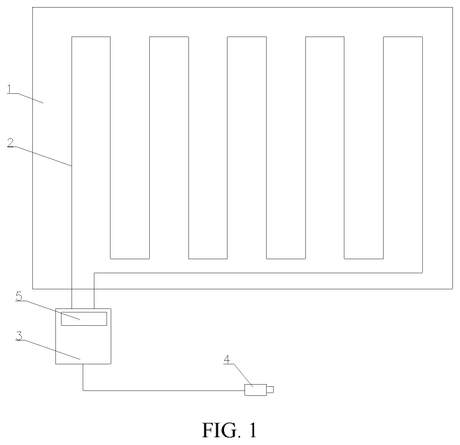

Referring to FIG. 1, a high-safety electric heating cold-resistant apparatus according to the present utility model includes a heat-dissipation fixing base 1, a fiber electric heating wire 2, a control switch 3, and a power connector 4. The fiber electric heating wire 2 is folded back and forth and fixed on the heat-dissipation fixing base 1. The control switch 3 is electrically connected to two ends of the fiber electric heating wire 2. The power connector 4 is electrically connected to the control switch 3 by using a conducting wire. The power connector 4 is connected to an external power source or connected to a storage battery. The power source provides electric energy, and the fiber electric heating wire 2 converts the electric energy into thermal energy. The heat-dissipation fixing base 1 is fixed on gloves, clothes, or a waistband. A type of the fiber electric heating wire 2 is a carbon-fiber electric heating wire. A temperature sensor is disposed on the heat-dissipation fixing base. The temperature sensor is connected to a display screen 5. A temperature of the heat-dissipation fixing base is detected by the temperature sensor and displayed by the display screen 5. Two sides of the heat-dissipation fixing base 1 stick to each other to form a velcro, and the velcro fixes the heating apparatus on the gloves, clothes, or waistband. The fiber electric heating wire 2 is sleeved with an insulation tube, and the insulation tube can prevent an electric shock of a human body. The fiber electric heating wire 2 goes through the two sides of the heat-dissipation fixing base 1 back and forth and is fixed on the heat-dissipation fixing base 1. Because the fiber electric heating wire 2 goes through the heat-dissipation fixing base 1 back and forth, the fiber electric heating wire 2 can be better fixed on the heat-dissipation fixing base 1. In comparison with a conventional adhesive manner, a manufacturing process is simple, costs are low, and fixing is more reliable.

For the high-safety electric heating cold-resistant apparatus according to the present utility model, the heat-dissipation fixing base 1, the fiber electric heating wire 2, the control switch 3, and the power connector 4 are applied in the heating apparatus, so that the apparatus is applicable to clothes, a waistband, or gloves. The apparatus has a simple structure, and can be applied conveniently. In addition, the apparatus has high safety, and can make a human body feel warmer, so that a thickness of clothes can be reduced. In addition, the apparatus can detect and display a temperature.

The foregoing embodiment is used to describe the present utility model, and not intended to limit the present utility model. Any solution obtained by making simple changes to the present utility model shall fall within the protection scope of the present utility model.

I claim:

1. A high-safety electric heating cold-resistant apparatus, comprising a heat-dissipation fixing base, a fiber electric heating wire, a control switch, and a power connector, wherein the fiber electric heating wire is folded back and forth and fixed on the heat-dissipation fixing base, the control switch is electrically connected to two ends of the fiber electric heating wire, and the power connector is electrically connected to the control switch by using a conducting wire.

2. The high-safety electric heating cold-resistant apparatus according to claim 1, wherein a temperature sensor is disposed on the heat-dissipation fixing base, the temperature sensor is connected to a display screen, and a temperature of the heat-dissipation fixing base is detected by the temperature sensor and displayed by the display screen.

3. The high-safety electric heating cold-resistant apparatus according to claim 1, wherein two sides of the heat-dissipation fixing base stick to each other to form a velcro.

4. The high-safety electric heating cold-resistant apparatus according to claim 1, wherein the fiber electric heating wire is sleeved with an insulation tube.

5. The high-safety electric heating cold-resistant apparatus according to claim 1, wherein the fiber electric heating wire goes through two sides of the heat-dissipation fixing base back and forth and is fixed on the heat-dissipation fixing base.
